(19) United States
(12) Patent Application Publication
(10) Pub. No.: US 2026/0031656 A1
(43) Pub. Date: Jan. 29, 2026

(54) WIRELESS POWER SUPPLY SYSTEM AND STORAGE MEDIUM

(71) Applicant: DENSO CORPORATION, Kariya-city (JP)

(72) Inventors: Masaya TAKAHASHI, Kariya-city (JP); Yusei NAKAYASHIKI, Kariya-city (JP); Masaki KANESAKI, Kariya-city (JP); Nobuhisa YAMAGUCHI, Kariya-city (JP)

(73) Assignee: DENSO CORPORATION, Kariya-city (JP)

(21) Appl. No.: 19/347,270

(22) Filed: Oct. 1, 2025

Related U.S. Application Data
(63) Continuation of application No. PCT/JP2024/013405, filed on Apr. 1, 2024.

(30) Foreign Application Priority Data
Apr. 5, 2023 (JP) 2023-061075

(51) Int. Cl. H02J 50/12; B60L 53/122; H02J 50/40

(52) U.S. Cl. CPC H02J 50/12; B60L 53/122; H02J 50/40; B60L 2210/30

(57) ABSTRACT

A wireless power supply system includes: an AC power source apparatus; a plurality of power transmission apparatuses connected in parallel to the AC power source apparatus; a power receiving apparatus configured to be supplied with power from the power transmission apparatuses in a wireless manner; and a power source voltage controller configured to control an output voltage of the AC power source apparatus, in which in a case where an output power of the AC power source apparatus exceeds a rated output power, the power source voltage controller is configured to perform a primary-side power reduction control to lower the output voltage so that the output power falls below a preset allowable output power.

### CROSS-REFERENCE TO RELATED APPLICATIONS

The present application is a continuation application of International Application No. PCT/JP2024/013405 filed on Apr. 1, 2024, which claims priority to Japanese Patent Application No. 2023-61075 filed on Apr. 5, 2023. The contents of these applications are incorporated herein by reference in their entirety.

### BACKGROUND

### 1. Technical Field

The present disclosure relates to a wireless power supply system and a storage medium.

### 2. Related Art

A known power supply system transmits power from a power transmission apparatus to supply the power to a vehicle equipped with a power receiving apparatus. In a power supply system described in WO2022/004034A, a plurality of power-transmitting resonant circuits are connected in parallel for a single power source to provide a power transmission apparatus, which enables the transmission of a large amount of power.

### SUMMARY

However, an increase in the number of power receiving apparatuses that receive power from a power supply system leads to concern that the supplied power may exceed a rated output power of a power source, stopping power transmission to all the power receiving apparatuses.

The present disclosure may be implemented as the following aspects.

According to an aspect of the present disclosure, a wireless power supply system is provided. The wireless power supply system includes: an alternating-current (AC) power source apparatus configured to supply an AC power with a predetermined operation frequency; a plurality of power transmission apparatuses connected in parallel to the AC power source apparatus, the plurality of power transmission apparatuses including a primary-side resonant circuit including a primary-side coil and a primary-side capacitor; a power receiving apparatus configured to be supplied with power from the power transmission apparatuses in a wireless manner, the power receiving apparatus including: a secondary-side resonant circuit including a secondary-side coil for magnetic coupling with the primary-side coil and a secondary-side capacitor; a rectifier circuit configured to rectify the AC power outputted from the secondary-side resonant circuit and convert the AC power to a direct-current (DC) power; a power-receiving-side controller configured to control the rectifier circuit; and load equipment configured to be supplied with the DC power at a constant current; and a power source voltage controller configured to control an output voltage of the AC power source apparatus, in which in a case where an output power of the AC power source apparatus exceeds a rated output power of the AC power source apparatus, the power source voltage controller is configured to perform a primary-side power reduction control to lower the output voltage so that the output power falls below a preset allowable output power.

According to the control apparatus in this form lowers, in a case where the output power of the AC power source apparatus exceeds the rated output power, the output voltage so that the output power falls below the preset allowable output power, which makes it possible to suppress the stoppage of power transmission to all the power receiving apparatuses as the output power of the AC power source apparatus becomes excessive to stop the operation of the AC power source apparatus.

### BRIEF DESCRIPTION OF THE DRAWING

The above and other objects, features, and advantages of the present disclosure will become more apparent from the following detailed description with reference to the accompanying drawings. The drawings are as follows.

FIG. 1 is an illustration depicting a schematic configuration of a wireless power supply system of a first embodiment.

FIG. 2 is an illustration depicting a circuit configuration of the wireless power supply system of the first embodiment.

FIG. 3 is a flowchart illustrating steps of a primary-side power reduction control of the first embodiment.

FIG. 4 is an illustration depicting a circuit configuration of a wireless power supply system of a second embodiment.

FIG. 5 is a flowchart illustrating steps of a power transmission state switching control of the second embodiment.

FIG. 6 is an illustration depicting a circuit configuration of a wireless power supply system of a third embodiment.

FIG. 7 is a flowchart illustrating steps of a power transmission state switching control of the third embodiment.

FIG. 8 is a flowchart illustrating steps of a secondary-side power reduction control of a fourth embodiment.

FIG. 9 is an illustration depicting a circuit configuration of a wireless power supply system of another embodiment.

FIG. 10 is an illustration depicting a circuit configuration of a wireless power supply system of another embodiment.

### DETAILED DESCRIPTION OF THE PREFERRED EMBODIMENTS

### A. First Embodiment

### A-1. System Configuration

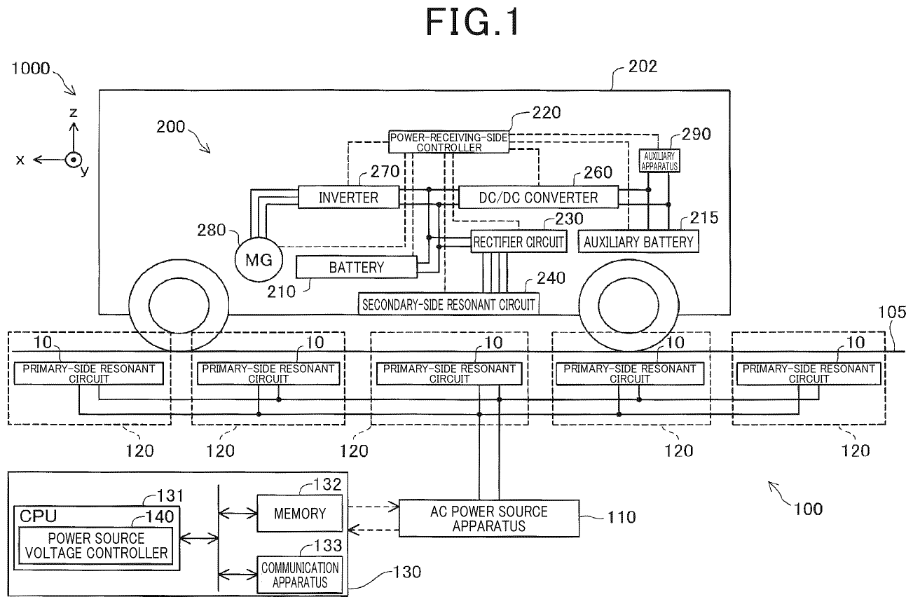

A wireless power supply system 1000 of the present embodiment illustrated in FIG. 1 includes a power transmission system 100 and a power receiving apparatus 200. In the present embodiment, the power transmission system 100 is buried under a roadway 105. The power receiving apparatus 200 is mounted on an electric vehicle 202, which is a moving body traveling on the roadway 105. In the present embodiment, the electric vehicle 202 is configured as an AGV (Automatic Guided Vehicle) traveling in a factory or a storehouse.

The wireless power supply system 1000, the power transmission system 100 supplies power to the power receiving apparatus 200 when the electric vehicle 202 travels on the roadway 105. The “traveling on the roadway 105” includes not only a case where the electric vehicle 202 is moving but also a case where the electric vehicle 202 is stopped near fixed equipment such as a delivery robot, a conveyor, or the like for the purpose of loading/unloading of a conveyed item, or the like. In FIG. 1, the x-axis direction shows a traveling direction of the electric vehicle 202, a y-axis direction shows a width direction of the electric vehicle 202, and a z-axis direction shows a vertically upward direction.

The power transmission system 100 includes an AC power source apparatus 110, a plurality of power transmission apparatuses 120, and a control apparatus 130. The AC power source apparatus 110 supplies an AC power with a predetermined operation frequency. A specific configuration of the AC power source apparatus 110 will be described later.

The plurality of power transmission apparatuses 120 are installed along the x-axis direction in the ground of the roadway 105. The power transmission apparatuses 120 may be installed at a location other than the underground of the roadway 105, for example, a side surface of conveyance equipment. The individual power transmission apparatuses 120 are connected in parallel to the AC power source apparatus 110, being supplied with AC power from the AC power source apparatus 110. The power transmission apparatuses 120 each include a primary-side resonant circuit 10. The primary-side resonant circuit 10 is to be supplied with AC power from the AC power source apparatus 110, transmitting the power to a later-described secondary-side resonant circuit 240 in a wireless manner. A specific configuration of the primary-side resonant circuit 10 will be described later.

The control apparatus 130 is configured as a computer including a CPU 131, a memory 132, and a communication apparatus 133. The CPU 131 functions as a power source voltage controller 140 by executing a program stored in advance in the memory 132.

The power source voltage controller 140 controls an output voltage of the AC power source apparatus 110. More specifically, unless the output power of the AC power source apparatus 110 exceeds a rated output power, the power source voltage controller 140 controls the AC power source apparatus 110 to output a preset constant voltage (hereinafter, also referred to as “specified voltage”). In the present embodiment, the specified voltage is set as a voltage at which the output power does not exceed the rated output power in simultaneously supplying power from two of the power transmission apparatuses 120 of the power transmission system 100 to the power receiving apparatus 200.

In contrast, in a case where the output power of the AC power source apparatus 110 exceeds the rated output power, the power source voltage controller 140 performs a primary-side power reduction control to lower the output voltage of the AC power source apparatus 110 so that the output power falls below an allowable output power. The “allowable output power” means a power set in advance as a power continuously suppliable by the AC power source apparatus 110.

It should be noted that the allowable output power only has to be set as a power equal to or less than the rated output power, and may be set as a power larger than the rated output power of the AC power source apparatus 110, for example, a power larger than the rated output power by several kW, insofar as not being large enough to cause the AC power source apparatus 110 to immediately stop operating. The voltage to be outputted during the primary-side power reduction control is also referred to as “reduced voltage” hereinbelow. In the present embodiment, the reduced voltage is determined so that the output power while the primary-side power reduction control is in progress is comparable to the output power when two of the power transmission apparatuses 120 simultaneously supply power to the power receiving apparatus 200 at the specified voltage. Steps of the primary-side power reduction control will be described later. It should be noted that the reduced voltage may be determined so that the output power while the primary-side power reduction control is in progress falls below the output power when two of the power transmission apparatuses 120 simultaneously supply power to the power receiving apparatus 200 at the specified voltage.

The power receiving apparatus 200 includes a battery 210, an auxiliary battery 215, a power-receiving-side controller 220, a rectifier circuit 230, the secondary-side resonant circuit 240, a DC/DC converter circuit 260, an inverter circuit 270, a motor generator 280, and an auxiliary apparatus 290. It should be noted that the power receiving apparatus 200 does not have to include the auxiliary apparatus 290 and, in this case, it also does not have to include the auxiliary battery 215 and the DC/DC converter circuit 260, accordingly. In the present embodiment, the secondary-side resonant circuit 240 is provided at a position facing the roadway 105, for example, on a lower surface of the electric vehicle 202. It should be noted that in a case where the power transmission apparatuses 120 are installed on a side surface of fixed equipment, the secondary-side resonant circuit 240 may be provided on a side surface of the electric vehicle 202. A specific configuration of the secondary-side resonant circuit 240 will be described later.

The secondary-side resonant circuit 240 is connected to the rectifier circuit 230 and the AC power received by the secondary-side resonant circuit 240 is to be converted to DC power through the rectifier circuit 230. An output of the rectifier circuit 230 is connected to the battery 210, a high-pressure side of the DC/DC converter circuit 260, and the inverter circuit 270. A lower-pressure side of the DC/DC converter circuit 260 is connected to the auxiliary battery 215 and the auxiliary apparatus 290. The inverter circuit 270 is connected to the motor generator 280. The DC power outputted from the rectifier circuit 230 is usable for charging the battery 210 and driving the motor generator 280 via the inverter circuit 270. Moreover, after the pressure of the voltage of the DC power outputted from the rectifier circuit 230 is reduced using the DC/DC converter circuit 260, the DC power is also allowed to be used for charging the auxiliary battery 215 and driving the auxiliary apparatus 290.

The battery 210 is a rechargeable battery that outputs a relatively high DC power for driving the motor generator 280, for example, a voltage of several tens of V to several hundreds of V. The motor generator 280 operates as a three-phase AC motor, generating a driving force for causing the electric vehicle 202 to travel. In decelerating the electric vehicle 202, the motor generator 280 operates as a generator, regenerating power. When the motor generator 280 operates as the motor, the inverter circuit 270 converts the power of the battery 210 to three-phase alternating current and supplies it to the motor generator 280. When the motor generator 280 operates as the generator, the inverter circuit 270 converts the three-phase alternating current regenerated by the motor generator 280 to direct current and supplies it to the battery 210. It should be noted that the battery 210 corresponds to “load equipment” in the present disclosure.

The DC/DC converter circuit 260 converts the output of the battery 210 to a voltage, for example, 12 V, lower than the output voltage of the battery 210 and supplies it to the auxiliary battery 215 and the auxiliary apparatus 290. The auxiliary battery 215 is a rechargeable battery for driving the auxiliary apparatus 290 and the voltage of the auxiliary battery 215 is relatively low. The auxiliary apparatus 290 includes peripheral apparatuses such as an air conditioner, an electric power steering apparatus, a headlight, a turn signal, and a wiper of the electric vehicle 202 and a variety of accessories of the electric vehicle 202.

The power-receiving-side controller 220 controls components in the electric vehicle 202 as well as the inverter circuit 270. In receiving supplied power in a wireless manner during traveling, the power-receiving-side controller 220 controls the secondary-side resonant circuit 240 to receive the power.

### A-2. Circuit Configuration

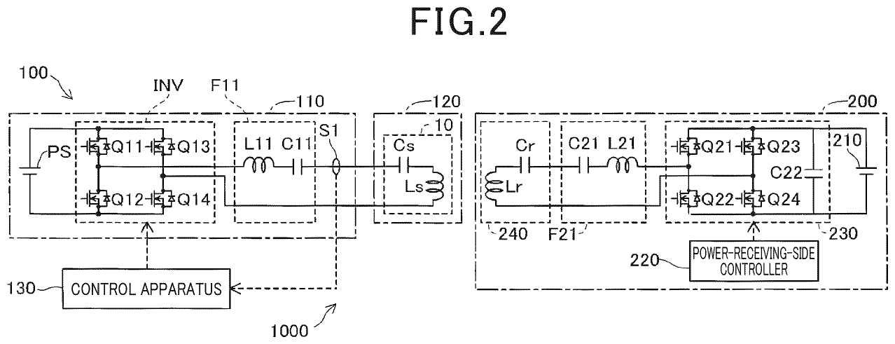

As illustrated in FIG. 2, the AC power source apparatus 110 includes a DC power source PS, an inverter circuit INV, a filter circuit F11, and a current sensor S1. The DC power source PS supplies DC power to the inverter circuit INV. The inverter circuit INV includes four switching devices Q11 to Q14 forming a bridge circuit. In the present embodiment, the switching devices Q1 to Q4 are implemented by MOSFETs (metal-oxide-semiconductor field-effect transistors). As a duty ratio or a phase shift amount is changed through a control of the switching devices Q1 to Q4 by the control apparatus 130, the inverter circuit INV converts the DC power supplied from the DC power source PS to an AC power with the preset operation frequency, which is an AC power at a voltage commanded by the power source voltage controller 140.

The filter circuit F11 reduces the passage of a noise component of the AC power inputted from the inverter circuit INV to pass an AC power in a targeted frequency band and supplies a current with a constant magnitude to the power transmission apparatus 120. The filter circuit F11 of the present embodiment is configured as a bandpass filter in which a coil L11 and a capacitor C11 are connected in series.

The current sensor S1 detects a current outputted from the AC power source apparatus 110 after passing through the filter circuit F11 (hereinafter, also referred to as “output current”). The current sensor S1 also transmits the detected output current to the control apparatus 130.

The power transmission apparatuses 120 include the primary-side resonant circuit 10 formed by connecting a primary-side capacitor Cs and a primary-side coil Ls in series. In the present embodiment, during the supply of AC power from the AC power source apparatus 110 to the power transmission apparatus 120, the primary-side resonant circuit 10 enters a resonate state at the operation frequency and, consequently, enters a power transmission state in which the primary-side resonant circuit 10 is able to supply power to the power receiving apparatus 200. In response to the entry of the power receiving apparatus 200 into a predetermined area (hereinafter, also referred to as “power transmission area”) for each of the power transmission apparatuses 120 when the primary-side resonant circuit 10 is in the power transmission state, the primary-side resonant circuit 10 starts power transmission to the power receiving apparatus 200.

The power receiving apparatus 200 includes a filter circuit F21 in addition to the configuration illustrated in FIG. 1. As illustrated in FIG. 2, the filter circuit F21 is connected between the secondary-side resonant circuit 240 and the rectifier circuit 230. In the secondary-side resonant circuit 240, a secondary-side coil Lr and a secondary-side capacitor Cr are connected in series. In the present embodiment, the filter circuit F21 is configured as a bandpass filter in which a coil L21 and a capacitor C21 are connected in series. The filter circuit F21 reduces the passage of a noise component of the AC power inputted from the secondary-side resonant circuit 240 to let an AC power in a targeted frequency band through and supplies a current with a constant magnitude to the rectifier circuit 230.

In the present embodiment, the rectifier circuit 230 includes four switching devices Q21 to Q24 forming a bridge circuit and a smoothing capacitor C22. In the present embodiment, the switching devices Q21 to Q24 are implemented by MOSFETs. As the ON/OFF states of the switching devices Q21 to Q24 are controlled by the power-receiving-side controller 220, the rectifier circuit 230 convers the AC power inputted from the filter circuit F21 to DC power and supplies it to the battery 210. Hereinafter, the magnitude of the DC power to be supplied to the battery 210 is also referred to as “secondary-side power.” It should be noted that the magnitude of the current to be supplied to the battery 210 is controlled to be constant through the filter circuit F21 and the rectifier circuit 230.

### A-3. Primary-Side Power Reduction Control

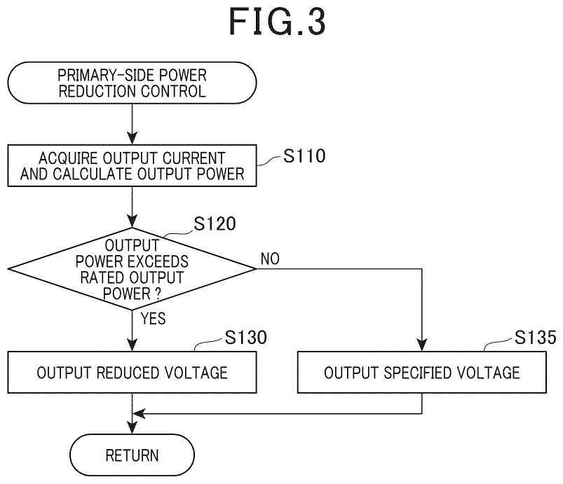

The power source voltage controller 140 controls the output voltage of the AC power source apparatus 110 by performing the primary-side power reduction control illustrated in FIG. 3 so that the output power of the AC power source apparatus 110 does not exceed the allowable output power. The primary-side power reduction control is to be started along with the start of the running of the power transmission system 100 and repeatedly performed during the running of the power transmission system 100.

In Step S110, the power source voltage controller 140 acquires the output current detected by the current sensor S1 from the current sensor S1 and calculates the output power of the AC power source apparatus 110. As described above, the output voltage of the AC power source apparatus 110 is controlled to reach a voltage commanded by the power source voltage controller 140, so that the power source voltage controller 140 is able to calculate the output power of the AC power source apparatus 110 using the output current acquired by the current sensor S1 and the voltage commanded for the AC power source apparatus 110 by the power source voltage controller 140.

In Step S120, the power source voltage controller 140 determines whether the output power exceeds the rated output power. In response to the output power being determined to exceed the rated output power (Step S120: Yes), the power source voltage controller 140 controls the AC power source apparatus 110 to output the above-described reduced voltage (Step S130). If a state where the output power is excessive with respect to the rated output power continues, the AC power source apparatus 110 may stop operating, resulting in the stoppage of the power transmission to all the power receiving apparatuses 200. In order to avoid such a situation, the power source voltage controller 140 controls the AC power source apparatus 110 to output the reduced voltage so that the above-described allowable output power is not exceeded.

In contrast, in response to the output power being determined not to exceed the rated output power (Step S120: No), the power source voltage controller 140 controls the AC power source apparatus 110 to output the above-described specified voltage (Step S135).

According to the wireless power supply system 1000 of the above-described embodiment, in a case where the output power of the AC power source apparatus 110 exceeds the rated output power, the output voltage is lowered so that the allowable output power is not exceeded, which makes it possible to suppress the stoppage of power transmission to all the power receiving apparatuses 200 as the output power of the AC power source apparatus 110 becomes excessive to stop the operation of the AC power source apparatus 110.

### B. Second Embodiment

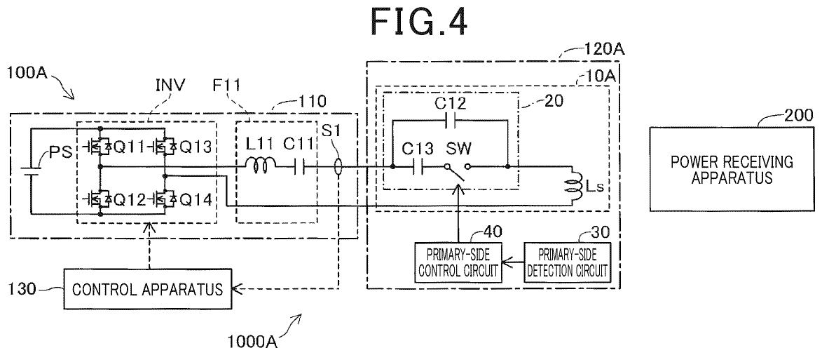

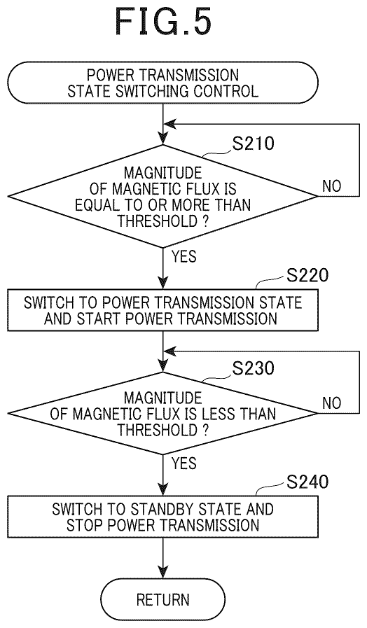

A wireless power supply system 1000A of a second embodiment is different from the wireless power supply system 1000 of the first embodiment in that it includes a power transmission apparatus 120A in place of the power transmission apparatus 120 as illustrated in FIG. 4. The wireless power supply system 1000A of the second embodiment is also different from the wireless power supply system 1000 of the first embodiment in that it performs a power transmission state switching control illustrated in FIG. 5. It should be noted that a system configuration of the wireless power supply system 1000A and the other steps of the primary-side power reduction control of the second embodiment are the same as those of the wireless power supply system 1000 of the first embodiment, so that the same reference numerals are used to refer to the same configuration and the same steps and the detailed descriptions thereof are omitted, accordingly.

### B-1. Circuit Configuration

A power transmission system 100A is different from the power transmission system 100 of the first embodiment in that it includes a power transmission apparatus 120A in place of the power transmission apparatus 120. The power transmission apparatus 120A includes a variable-impedance device in place of the primary-side capacitor Cs and the primary-side coil Ls and the impedance variable device 20 form a primary-side resonant circuit 10A. The power transmission apparatus 120A further includes a primary-side detection circuit 30 and a primary-side control circuit 40.

The impedance variable device 20 is connected between the AC power source apparatus 110 and the primary-side coil Ls. The impedance variable device 20 includes two capacitor 12 and capacitor 13 and a switch SW. The capacitor 12 and the primary-side coil Ls are connected in series. The capacitor 13 and the switch SW are connected in series, and the capacitor 13 and the switch SW connected in series are connected to the capacitor 12 in parallel. The switch SW may be configured to switch a mechanical contact point such as a relay in responses to an external instruction or may be a component including a semiconductor device such as a MOS-FET or an analog switch.

A capacitance of the impedance variable device 20 is changed by switching the switch SW ON and OFF. When the switch SW is ON, the capacitor 13 is connected to the primary-side coil Ls. At this time, the capacitance of the impedance variable device 20 is equal to the sum of a capacitance of the capacitor 12 and a capacitance of the capacitor 13. However, when the switch SW is OFF, the capacitor 13 is disconnected from the primary-side coil Ls. At this time, the capacitance of the impedance variable device 20 is equal to the capacitance of the capacitor 12. The capacitance of the impedance variable device 20 changes in this manner, so that an impedance of the primary-side resonant circuit 10A when the switch SW is ON is lower as compared with when the switch SW is OFF. With such a change in the impedance of the primary-side resonant circuit 10A, a resonant state of the primary-side resonant circuit 10A also changes. In the present embodiment, when the switch SW is ON, the primary-side resonant circuit 10A goes into the resonant state at the operation frequency and, consequently, into the power transmission state. Contrarily, when the switch SW is OFF, the primary-side resonant circuit 10A goes into a non-resonant state at the operation frequency and, consequently, into a standby state. In the standby state, the power transmission apparatus 120A causes a standby current, which is smaller than a current flowing in the power transmission state, to flow through the primary-side coil Ls and waits until a transition to the power transmission state is achieved.

The primary-side detection circuit 30 is configured as a sensor that detects a magnitude of a magnetic flux interlinked with the primary-side coil. In the present embodiment, the primary-side detection circuit 30 detects voltages at opposite ends of the primary-side coil Ls and detects the magnitude of the magnetic flux using a change in the voltages. The primary-side detection circuit 30 outputs a signal indicating the detected magnitude of the magnetic flux to the primary-side control circuit 40.

The primary-side control circuit 40 drives the switch SW using the signal outputted from the primary-side detection circuit 30 to switch ON/OFF the switch SW. A specific process in the primary-side control circuit 40 will be described in “Power Transmission State Switching Control” described below.

### B-2. Power Transmission State Switching Control

The power transmission apparatus 120A controls the power transmission state of the power transmission apparatus 120A by performing the power transmission state switching control illustrated in FIG. 5 in accordance with the degree of a magnetic coupling between the power transmission apparatus 120A and the power receiving apparatus 200. The power transmission state switching control is to be started along with the start of the running of the power transmission system 100A and repeatedly performed in parallel for each power transmission apparatus 120A during the running of the power transmission system 100A.

In Step S210, the primary-side control circuit 40 determines whether the magnitude of the magnetic flux indicated by the signal outputted from the primary-side detection circuit 30 is equal to or more than a preset threshold. The magnitude of the magnetic flux, which changes depending on the degree of the magnetic coupling between the power transmission apparatus 120A and the power receiving apparatus 200, increases as the power transmission apparatus 120A approaches the power receiving apparatus 200. The threshold of the magnitude of the magnetic flux is specified and set as a value when the power receiving apparatus 200 enters the power transmission area of the power transmission apparatus 120A by performing a simulation or the like in advance. The primary-side control circuit 40 repeatedly makes this determination as long as the magnitude of the magnetic flux is determined to be less than the threshold (Step S210: No).

In response to the magnitude of the magnetic flux being determined to be equal to or more than the threshold (Step S210: Yes), the primary-side control circuit 40 switches on the switch SW to switch the primary-side resonant circuit 10A to the power transmission state, causing the power transmission apparatus 120A to start power transmission (Step S220).

In Step S230, the primary-side control circuit 40 determines whether the magnitude of the magnetic flux indicated by the signal outputted from the primary-side detection circuit 30 is less than the preset threshold. The primary-side control circuit 40 repeatedly performs this determination to cause the power transmission apparatus 120A to continue the power transmission as long as the magnitude of the magnetic flux is determined to be equal to or more than the threshold (Step S230: No).

In response to the magnitude of the magnetic flux being determined to be equal to or more than the threshold (Step S230: Yes), the primary-side control circuit 40 switches off the switch SW to switch the primary-side resonant circuit 10A to the standby state, causing the power transmission apparatus 120A to stop the power transmission (Step S240). After that, the primary-side control circuit 40 again performs Step S210.

According to the wireless power supply system 1000A of the above-described second embodiment, in a case where the primary-side detection circuit 30 detects a decrease in the magnetic flux, a transition from the power transmission state to the standby state is performed to reduce the current, which makes it possible to further suppress the stoppage of the operation of the AC power source apparatus 110 as the output power of the AC power source apparatus 110 becomes excessive.

### C. Third Embodiment

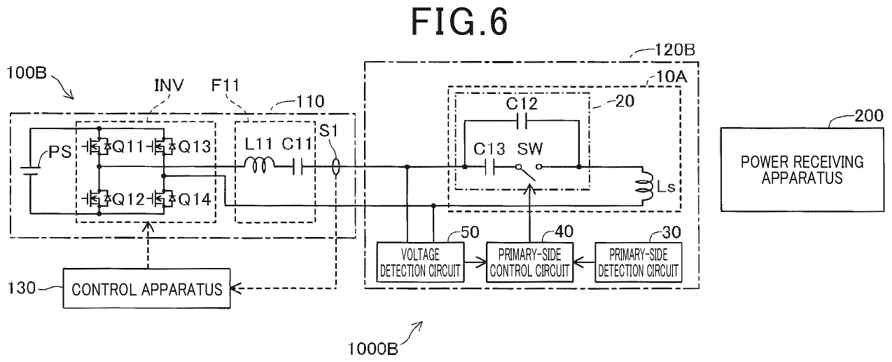

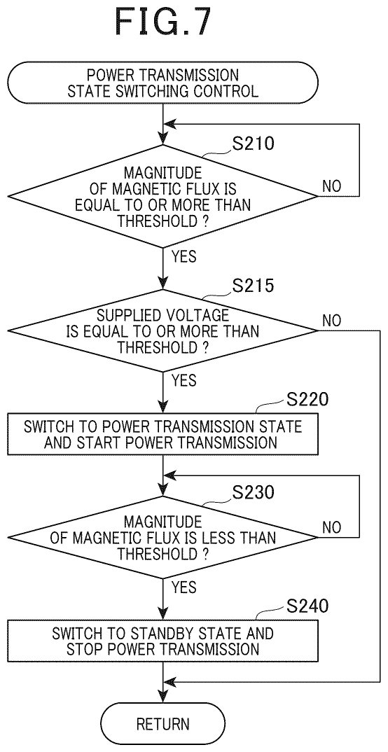

A wireless power supply system 1000B of a third embodiment is different from the wireless power supply system 1000A of the second embodiment in that it further includes a voltage detection circuit 50 as illustrated in FIG. 6. The wireless power supply system 1000B of the third embodiment is also different from the wireless power supply system 1000A of the second embodiment in that Step S215 is to be performed after Step S210 during the power transmission state switching control illustrated in FIG. 7. It should be noted that a system configuration and the other steps of the primary-side power reduction control and the power transmission state switching control of the wireless power supply system 1000B of the third embodiment are the same as those of the wireless power supply system 1000A of the second embodiment, so that the same reference numerals are used to refer to the same configuration and the same steps and the detailed descriptions thereof are omitted, accordingly.

A power transmission apparatus 120B is different from the power transmission apparatus 120A of the second embodiment in that it includes the voltage detection circuit 50 in addition to the configuration of the above-described power transmission apparatus 120A as illustrated in FIG. 6. The voltage detection circuit 50 detects a voltage supplied to the power transmission apparatus 120B between the impedance variable device 20 and the AC power source apparatus 110. The power transmission apparatus 120B also outputs a signal indicating the detected supplied voltage to the primary-side detection circuit 30.

As illustrated in FIG. 7, during the power transmission state switching control, the primary-side control circuit 40 determines, after Step S210, whether the supplied voltage indicated by a signal outputted from the voltage detection circuit 50 is equal to or more than a preset threshold (Step S215). The threshold of the supplied voltage is set as a value comparable to the above-described specified voltage. Here, a case where the supplied voltage is not equal to or less than the threshold corresponds to a case where the above-described primary-side power reduction control is in progress and the supplied voltage falls below the specified voltage.

In response to the supplied voltage being equal to or more than the threshold (Step S215: Yes), the primary-side control circuit 40 again performs Step S210 after performing Step S220 to Step S240 as in the above-described second embodiment. In contrast, in response to the supplied voltage being less than the threshold (Step S215: No), the primary-side control circuit 40 again performs Step S210 without performing Step S220 to Step S240. As seen from the above, during the power transmission state switching control of the present embodiment, in a case where the supplied voltage is less than the threshold, in other words, the above-described primary-side power reduction control is in progress, the primary-side control circuit 40 does not cause the state of the power transmission apparatus 120B to transition to the power transmission state from the standby state even in a case where the power receiving apparatus 200 enters the power transmission area of the power transmission apparatus 120B and the magnitude of the magnetic flux becomes equal to or more than the threshold.

According to the wireless power supply system 1000B of the above-described third embodiment, as long as the primary-side power reduction control is being performed, the state of the power transmission apparatus 120B is not caused to transition from the standby state to the power transmission state even though an increase in magnetic flux is detected. This makes it possible to suppress the stoppage of the power transmission to all the power receiving apparatuses 200 due to the stoppage of the operation of the AC power source apparatus 110 caused when the output power to the AC power source apparatus 110 becomes excessive as the power supply for further power receiving apparatus 200 is started while the primary-side power reduction control is in progress.

### D. Fourth Embodiment

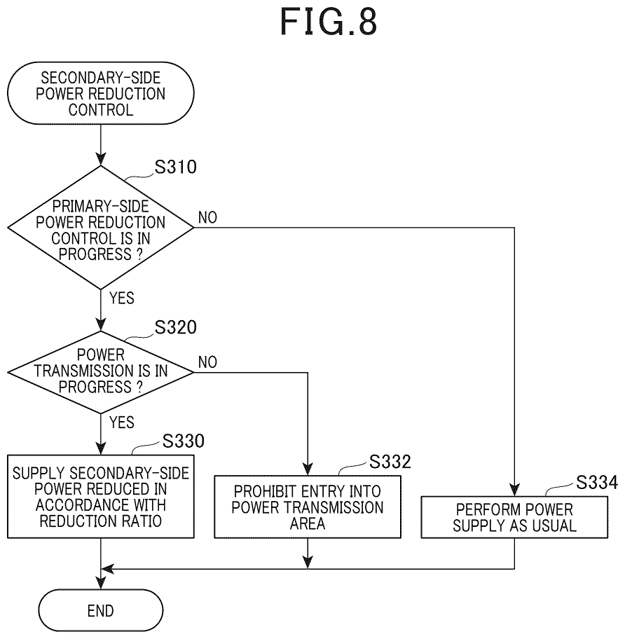

A wireless power supply system 1000B of a fourth embodiment is different from the wireless power supply system 1000B of the third embodiment in that the power source voltage controller 140 sends a notification to the power receiving apparatus 200 and the power-receiving-side controller 220 performs a secondary-side power reduction control illustrated in FIG. 8. Moreover, in the present embodiment, the power source voltage controller 140 and the power receiving apparatus 200 are configured to be able to communicate with each other. It should be noted that a system configuration of the wireless power supply system 1000B and the other steps of the primary-side power reduction control and the power transmission state switching control of the fourth embodiment are the same as those of the wireless power supply system 1000B of the third embodiment, so that the same reference numerals are used to refer to the same configuration and the same steps and the detailed descriptions thereof are omitted, accordingly.

The power source voltage controller 140 of the present embodiment sends, to the power receiving apparatus 200, a notification containing a control state signal indicating whether the primary-side power reduction control is in progress and information indicating a reduction ratio through the secondary-side power reduction control. The “reduction ratio” means a ratio indicating the degree of a reduction in secondary-side power through the secondary-side power reduction control. More specifically, the reduction ratio means a ratio of the secondary-side power after the secondary-side power reduction control is performed to the secondary-side power before the secondary-side power reduction control is performed. In the present embodiment, the AC power source apparatus 110 calculates the reduction ratio by dividing the rated output power of the AC power source apparatus 110 by a value given by multiplying a predetermined rated consumption power of the power receiving apparatus 200 by the number of the power receiving apparatuses 200 currently being supplied with power. The power source voltage controller 140 is able to identify the number of the power receiving apparatuses 200 currently being supplied with power using the output current detected by the current sensor S1. One reason for this is that the output current increases in proportion to the number of the power receiving apparatuses 200 being supplied with power.

In response to receiving the notification from the power source voltage controller 140, the power receiving apparatus 200 performs the secondary-side power reduction control illustrated in FIG. 8. In Step S310, the power-receiving-side controller 220 determines whether the control state signal contained in the received notification indicates that the primary-side power reduction control is in progress. In response to determining that it is indicated that the primary-side power reduction control is not in progress (Step S310: No), the power receiving apparatus 200 is supplied with power as usual (Step S334) and terminates the secondary-side power reduction control.

In response to the primary-side power reduction control being determined to be in progress (Step S310: Yes), the power-receiving-side controller 220 determines whether power supply is in progress in the secondary-side resonant circuit 240 (Step S320). This determination may be performed by, for example, causing a non-illustrated voltage sensor to detect voltages at opposite ends of the secondary-side coil Lr and using a change in the voltages.

In response to power supply being in progress (Step S320: Yes), the power-receiving-side controller 220 controls the rectifier circuit 230 to supply the secondary-side power, which is reduced in accordance with the above-described reduction ratio, to the battery 210 (Step S330). More specifically, the power-receiving-side controller 220 supplies the reduced secondary-side power to the battery 210 by adjusting a period of a commutation mode where the switching device Q22 and the switching device Q24 are simultaneously switched on in the rectifier circuit 230. After that, the power receiving apparatus 200 terminates the secondary-side power reduction control.

In response to no power supply being in progress (Step S320: No), the power-receiving-side controller 220 prohibits the entry of the electric vehicle 202 into the power transmission area (Step S332). More specifically, the power-receiving-side controller 220 controls, via a non-illustrated ECU mounted on the electric vehicle 202 to control the traveling of the electric vehicle 202, the electric vehicle 202 to, for example, bypass the power transmission area during traveling. Such a control of the electric vehicle 202 makes it possible to prohibit the start of further power supply to the power receiving apparatus 200. After that, the power receiving apparatus 200 terminates the secondary-side power reduction control.

According to the wireless power supply system 1000B of the above-described fourth embodiment, in a case where a notification indicating that the primary-side power reduction control is in progress and no power supply is in progress in the secondary-side resonant circuit 240, the start of further power supply to the power receiving apparatus 200 is prohibited. This makes it possible to suppress the stoppage of the power transmission to all the power receiving apparatuses 200 due to the stoppage of the operation of the AC power source apparatus 110 caused when the output power to the AC power source apparatus 110 becomes excessive as the power supply to further power receiving apparatus 200 is started while the primary-side power reduction control is in progress.

Moreover, in a case where a notification indicating that the primary-side power reduction control is in progress is received and power supply is in progress in the secondary-side resonant circuit 240, the wireless power supply system 1000B of the present embodiment reduces the secondary-side power in accordance with the set reduction ratio and performs power supply. This reduces the current flowing through the power transmission apparatus 120B that is transmitting power to the power receiving apparatus 200, which makes it possible to suppress the stoppage of power transmission to all the power receiving apparatuses 200 as the output power to the AC power source apparatus 110 becomes excessive to stop the operation of the AC power source apparatus 110.

Moreover, the AC power source apparatus 110 sets the reduction ratio as a value given by dividing the rated output power of the AC power source apparatus 110 by a value given by multiplying the predetermined rated consumption power of the power receiving apparatus 200 by the number of the power receiving apparatuses 200 currently being supplied with power, which enables the AC power source apparatus 110 to output a power close to the rated output power. This makes it possible to reduce a decrease in power supply efficiency relative to the power receiving apparatus 200 resulting from an excessive reduction in the output power of the AC power source apparatus 110.

### E. Fifth Embodiment

A wireless power supply system 1000B of a fifth embodiment is different from the wireless power supply system 1000B of the fourth embodiment in a method of calculating the reduction ratio. It should be noted that a system configuration of the wireless power supply system 1000B and the other steps of the primary-side power reduction control, the power transmission state switching control, and the secondary-side power reduction control of the fifth embodiment are the same as those of the wireless power supply system 1000B of the fourth embodiment, so that the same reference numerals are used to refer to the same configuration and the same steps and the detailed descriptions thereof are omitted, accordingly.

In the present embodiment, the AC power source apparatus 110 calculates the reduction ratio by dividing the rated output voltage of the AC power source apparatus 110 by a current output voltage of the AC power source apparatus 110. The current output voltage of the AC power source apparatus 110 changes with a change in coefficient of coupling between the primary-side coil Ls and the secondary-side coil Lr depending on a positional relationship between the power transmission apparatus 120B and the power receiving apparatus 200 even though the number of the power receiving apparatuses 200 being supplied with power is not changed with respect to the power transmission system 100B. More specifically, in a case where the power transmission apparatus 120 is distant from the power receiving apparatus 200, the coefficient of coupling decreases and the secondary-side power, which is lower than the rated consumption power of the power receiving apparatus 200, is to be supplied. In such a case, if the secondary-side power of the power receiving apparatus 200 is reduced in accordance with the reduction ratio determined using the rated consumption power of the power receiving apparatus 200, the secondary-side power may be excessively reduced to be considerably lower than the rated output power of the AC power source apparatus 110, resulting in a lowered power supply efficiency relative to the power receiving apparatus 200. According to the method of calculating the reduction ratio of the present embodiment, the reduction ratio is calculated using the current output voltage, which reflects the degree of the coefficient of coupling changeable depending on the positional relationship between each power transmission apparatus 120B and each power receiving apparatus 200, so that such a problem is avoidable.

According to the wireless power supply system 1000B of the fifth embodiment as described above, the reduction ratio is set as a value given by dividing the rated output voltage of the AC power source apparatus 110 by the current output voltage of the AC power source apparatus 110, which enables the AC power source apparatus 110 to output a power close to the rated output power in accordance with the current output power. This makes it possible to further reduce a decrease in power supply efficiency relative to the power receiving apparatus 200 resulting from an excessive reduction in the output power of the AC power source apparatus 110.

### F. Other Embodiments

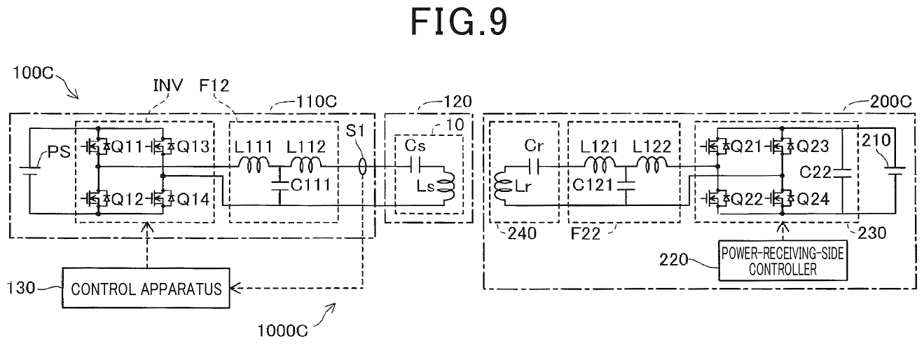

(F1) In the above-described embodiments, the AC power source apparatus 110 includes the filter circuit F11 and the power receiving apparatus 200 includes the filter circuit F21; however, the present disclosure is not limited thereto. The wireless power supply system may include an AC power source apparatus 110C including a filter circuit F12 in place of the filter circuit F11 and a power receiving apparatus 200C including a filter circuit F22 in place of the filter circuit F21 as a wireless power supply system 1000C illustrated in FIG. 9. The filter circuit F12 is configured as an immittance filter, in which a coil L111 and a coil L112 are connected in series and a capacitor C111 is connected in parallel between the coil L111 and the coil L112. The filter circuit F22 is configured as an immittance filter, in which a coil L121 and a coil L122 are connected in series and a capacitor C121 is connected in parallel between the coil L121 and the coil L122. The wireless power supply system 1000C in such a form also produces effects similar to the those of the above-described embodiments.

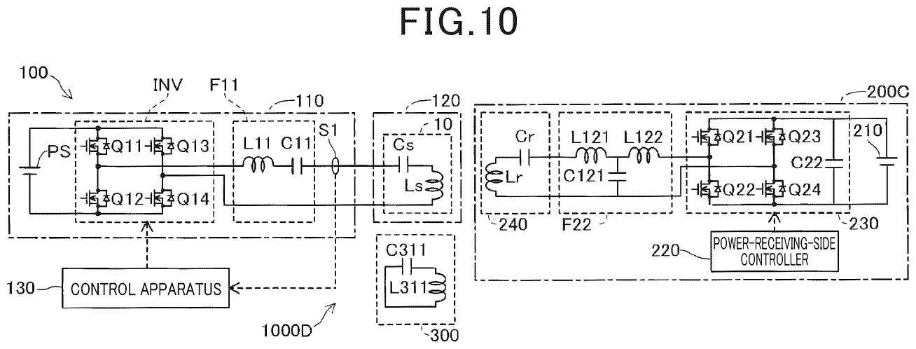

Alternatively, the wireless power supply system may include the AC power source apparatus 110 of the first embodiment including the filter circuit F11 configured as a band-pass filter, the above-described power receiving apparatus 200C including F22 configured as an immittance filter, and a tertiary-side resonant circuit 300 as a wireless power supply system 1000D illustrated in FIG. 10. The tertiary-side resonant circuit 300 includes a closed circuit in which a tertiary-side coil L311 and a tertiary-side capacitor C311 are connected in series. Moreover, the tertiary-side resonant circuit 300 is disposed so that the tertiary-side coil L311 is magnetically coupled to the primary-side coil Ls of the primary-side resonant circuit 10 and the secondary-side coil Lr of the secondary-side resonant circuit 240. The wireless power supply system 1000D in such a form also produces effects similar to the those of the above-described embodiments.
(F2) In the above-described embodiments, the AC power source apparatus 110 includes the filter circuit F11 and the power receiving apparatus 200 includes the filter circuit F21; however, the present disclosure is not limited thereto. In a case where the power to be supplied by the wireless power supply system 1000 is small, neither the AC power source apparatus 110 nor the power receiving apparatus 200 has to include a filter circuit. The wireless power supply system 1000 in such a form also produces effects similar to the those of the above-described embodiments.
(F3) In the above-described second embodiment, the primary-side control circuit 40 is configured as a sensor that detects the magnitude of the magnetic flux interlinked with the primary-side coil using a change in the voltages at the opposite ends of the primary-side coil Ls; however, the present disclosure is not limited thereto. For example, the primary-side control circuit 40 may detect the magnitude of the magnetic flux near the primary-side coil using a change in the current flowing through a detection coil disposed near the primary-side coil Ls. The wireless power supply system 1000A in such a form also produces effects similar to those of the above-described second embodiment.
(F4) In the above-described third embodiment, by causing the voltage detection circuit 50 to detect the voltage supplied to the power transmission apparatus 120B, the primary-side detection circuit 30 determines whether the primary-side power reduction control is being performed; however, the present disclosure is not limited thereto. With use of the control state signal sent from the power source voltage controller 140 and that indicates whether the primary-side power reduction control is in progress, the primary-side detection circuit 30 may determine whether the primary-side power reduction control is being performed. The wireless power supply system 1000B in such a form requires no voltage detection circuit 50, which makes it possible to reduce the complication of the system configuration of the wireless power supply system 1000B.
(F5) In the above-described fourth embodiment, the power source voltage controller 140 sends a notification directly to the power-receiving-side controller 220; however, the present disclosure is not limited thereto. In a configuration further including an operating system that controls a plurality of power receiving apparatuses 200, the power source voltage controller 140 may send a notification to the power-receiving-side controller 220 through the operating system. The wireless power supply system 1000B in such a form also produces effects similar to the those of the above-described embodiments.
(F6) In the above-described fourth embodiment, in a case where the primary-side power reduction control is in progress and the power supply to the power receiving apparatus 200 is not in progress, the power-receiving-side controller 220 prohibits the start of further power supply to the power receiving apparatus 200; however, the present disclosure is not limited thereto. In such a case, a control to reduce a speed when the power receiving apparatus 200 enters the power transmission area may be performed. Performing such a control makes it possible to increase time that elapses before the coefficient of coupling reaches the maximum to maximize the current flowing through the power transmission apparatus 120B after the power receiving apparatus 200 enters the power transmission area. That is to say, it is possible to increase the likelihood that before the output power of the AC power source apparatus 110 exceeds the rated output power due to power supply to the newly entering power receiving apparatus 200, the power supply to further power receiving apparatus 200 is completed to lower the output power. Thus, such a control is also able to further reduce concern that the output power of the AC power source apparatus 110 exceeds the rated output power.

The control apparatus 130 and the method thereof described in the present disclosure may be implemented by a dedicated computer provided by a processor programmed to execute one or a plurality of functions embodied by a computer program, and a memory. Alternatively, the control apparatus 130 and the method thereof described in the present disclosure may be implemented by a dedicated computer provided by a processor including one or more dedicated hardware logic circuits. Furthermore, the control apparatus 130 and the method thereof described in the present disclosure may be implemented by one or more dedicated computers including a combination of a processor programmed to execute one or a plurality of functions, a memory, and one or more hardware logic circuits. Additionally, the computer program may be stored in a computer-readable non-transitory tangible storage medium as instructions to be executed by a computer.

The present disclosure is not limited to the embodiments described above and may be implemented in various configurations within the scope that does not depart from the essence thereof. For example, a technical feature in the embodiments that corresponds to a technical feature in the aspects described in the section “Summary of the Invention” may be replaced or combined, if necessary, in order to solve part or all of the above-described problems or achieve part or all of the above-described effects. Moreover, a technical feature may be deleted, if necessary, unless it is described as being essential herein.

### (Form 1)

A wireless power supply system (1000, 1000A, 1000B, 1000C, 1000D) including:
an alternating-current (AC) power source apparatus (110, 110C) configured to supply an AC power with a predetermined operation frequency;
a plurality of power transmission apparatuses (120, 120A, 120B) connected in parallel to the AC power source apparatus, the plurality of power transmission apparatuses including a primary-side resonant circuit (10, 10A) including a primary-side coil (Ls) and a primary-side capacitor (Cs);
a power receiving apparatus (200, 200C) configured to be supplied with power from the power transmission apparatuses in a wireless manner, the power receiving apparatus including:
   a secondary-side resonant circuit including a secondary-side coil (Lr) for magnetic coupling with the primary-side coil and a secondary-side capacitor (Cr);
   a rectifier circuit (230) configured to rectify the AC power outputted from the secondary-side resonant circuit and convert the AC power to a direct-current (DC) power;
   a power-receiving-side controller (220) configured to control the rectifier circuit; and
   load equipment (210) configured to be supplied with the DC power at a constant current; and
a power source voltage controller (140) configured to control an output voltage of the AC power source apparatus, in which
in a case where an output power of the AC power source apparatus exceeds a rated output power of the AC power source apparatus, the power source voltage controller is configured to perform a primary-side power reduction control to lower the output voltage so that the output power falls below a preset allowable output power.

### (Form 2)

The wireless power supply system according to Form 1, in which
the plurality of power transmission apparatuses each further includes:
   a variable-impedance device (20) for switching a state of the power transmission apparatus between a power transmission state and a standby state, the impedance variable device being connected between the primary-side coil and the AC power source apparatus;
   a primary-side detection circuit (30) for detecting at least one of a magnitude of a magnetic flux interlinked with the primary-side coil or a magnitude of a magnetic flux near the primary-side coil; and
   a primary-side control circuit (40) configured to change an impedance of the impedance variable device using a value detected by the primary-side detection circuit, in which
the primary-side control circuit is configured to cause a state of the power transmission apparatus to:
transition from the standby state to the power transmission state by lowering the impedance of the impedance variable device in a first case where the primary-side detection circuit detects an increase in the magnetic flux interlinked with the primary-side coil or the magnetic flux near the primary-side coil, and
transition from the power transmission state to the standby state by increasing the impedance of the impedance variable device in a second case where the primary-side detection circuit detects a decrease in the magnetic flux interlinked with the primary-side coil or the magnetic flux near the primary-side coil.

### (Form 3)

The wireless power supply system according to Form 2, in which
as long as the primary-side power reduction control is being performed, the primary-side control circuit is configured to cause no transition from the standby state to the power transmission state even in the first case.

### (Form 4)

The wireless power supply system according to Form 3, in which
the power transmission apparatus further includes a voltage detection circuit (50) configured to detect a voltage supplied to the power transmission apparatus, in which
as long as the voltage detected by the voltage detection circuit is less than a preset threshold, the primary-side control circuit is configured to cause no transition from the standby state to the power transmission state even in the first case.

### (Form 5)

The wireless power supply system according to any one of Form 1 to Form 4, in which
in a case where the primary-side power reduction control is being performed, the power source voltage controller is configured to issue a notification indicating that the primary-side power reduction control is being performed to the power receiving apparatus.

### (Form 6)

The wireless power supply system according to Form 5, in which
as long as the primary-side power reduction control is being performed, the power source voltage controller is configured to prohibit start of further power supply to the power receiving apparatus.

### (Form 7)

The wireless power supply system according to Form 5 or Form 6, in which
the power-receiving-side controller is configured to control, in response to receiving the notification, the rectifier circuit to perform a secondary-side power reduction control to reduce a secondary-side power to be supplied to the load equipment, thereby reducing the secondary-side power so that a ratio of the secondary-side power after the secondary-side power reduction control is performed to the secondary-side power before the secondary-side power reduction control is performed reaches a set reduction ratio.

### (Form 8)

The wireless power supply system according to Form 7, in which
the reduction ratio is a value given by dividing the rated output power by a value given by multiplying a rated consumption power of the power receiving apparatus by the number of the power receiving apparatus.

### (Form 9)

The wireless power supply system according to Form 7, in which
the reduction ratio is a value given by dividing a rated output voltage of the AC power source apparatus by a current value of the output voltage.

### (Form 10)

A computer program for controlling a wireless power supply system,
the wireless power supply system including:
   an AC power source apparatus configured to supply an AC power with a predetermined operation frequency;
   a plurality of power transmission apparatuses connected in parallel with respect to the AC power source apparatus, the plurality of power transmission apparatuses including a primary-side resonant circuit including a primary-side coil and a primary-side capacitor; and
   a power receiving apparatus configured to be supplied with power from the power transmission apparatuses in a wireless manner, the power receiving apparatus including:
      a secondary-side resonant circuit including a secondary-side coil for magnetic coupling with the primary-side coil and a secondary-side capacitor;
      a rectifier circuit configured to rectify the AC power outputted from the secondary-side resonant circuit and convert the AC power to a DC power;
      a power-receiving-side controller configured to control the rectifier circuit; and
      load equipment configured to be supplied with the DC power at a constant current,
the computer program being configured to cause, in a case where an output power of the AC power source apparatus exceeds a rated output power of the AC power source apparatus, a computer to implement a function to lower an output voltage of the AC power source apparatus so that the output power falls below a preset allowable output power.

### (Form 11)

A power transmission apparatus supplying power to a power receiving apparatus in a wireless manner,
the power transmission apparatus including a primary-side resonant circuit including a primary-side coil and a primary-side capacitor, the power transmission apparatus being connected in parallel with another power transmission apparatus with respect to an AC power source apparatus configured to supply an AC power with a predetermined operation frequency,
the power receiving apparatus including:
   a secondary-side resonant circuit including a secondary-side coil for magnetic coupling with the primary-side coil and a secondary-side capacitor;
   a rectifier circuit configured to rectify the AC power outputted from the secondary-side resonant circuit and convert the AC power to a DC power;
   a power-receiving-side controller configured to control the rectifier circuit; and
   load equipment configured to be supplied with the DC power at a constant current, in which
in a case where an output power of the AC power source apparatus exceeds a rated output power of the AC power source apparatus, the AC power source apparatus is configured to lower an output voltage of the AC power source apparatus so that the output power falls below a preset allowable output power.

### (Form 12)

A power receiving apparatus receiving power from a power transmission apparatus in a wireless manner, the power transmission apparatus including a primary-side resonant circuit including a primary-side coil and a primary-side capacitor, the power transmission apparatus being connected in parallel with anther power transmission apparatus with respect to an AC power source apparatus configured to supply an AC power with a predetermined operation frequency,
the power receiving apparatus including:
   a secondary-side resonant circuit including a secondary-side coil for magnetic coupling with the primary-side coil and a secondary-side capacitor;
   a rectifier circuit configured to rectify the AC power outputted from the secondary-side resonant circuit and convert the AC power to a DC power;
   a power-receiving-side controller configured to control the rectifier circuit; and
   load equipment configured to be supplied with the DC power at a constant current, in which
in a case where an output power of the AC power source apparatus exceeds a rated output power of the AC power source apparatus, the AC power source apparatus is configured to lower an output voltage of the AC power source apparatus so that the output power falls below a preset allowable output power.

What is claimed is:

1. A wireless power supply system comprising:
an alternating-current (AC) power source apparatus configured to supply an AC power with a predetermined operation frequency;
a plurality of power transmission apparatuses connected in parallel to the AC power source apparatus, the plurality of power transmission apparatuses including a primary-side resonant circuit including a primary-side coil and a primary-side capacitor;
a power receiving apparatus configured to be supplied with power from the power transmission apparatuses in a wireless manner, the power receiving apparatus including:
a secondary-side resonant circuit including a secondary-side coil for magnetic coupling with the primary-side coil and a secondary-side capacitor;
a rectifier circuit configured to rectify the AC power outputted from the secondary-side resonant circuit and convert the AC power to a direct-current power;
a power-receiving-side controller configured to control the rectifier circuit; and
load equipment configured to be supplied with the DC power at a constant current; and
a power source voltage controller configured to control an output voltage of the AC power source apparatus, wherein
in a case where an output power of the AC power source apparatus exceeds a rated output power of the AC power source apparatus, the power source voltage controller is configured to perform a primary-side power reduction control to lower the output voltage so that the output power falls below a preset allowable output power.

2. The wireless power supply system according to claim 1, wherein
the plurality of power transmission apparatuses each further includes:
a variable-impedance device for switching a state of the power transmission apparatus between a power transmission state and a standby state, the impedance variable device being connected between the primary-side coil and the AC power source apparatus;
a primary-side detection circuit for detecting at least one of a magnitude of a magnetic flux interlinked with the primary-side coil or a magnitude of a magnetic flux near the primary-side coil; and
a primary-side control circuit configured to change an impedance of the impedance variable device using a value detected by the primary-side detection circuit, wherein
the primary-side control circuit is configured to cause a state of the power transmission apparatus to:
transition from the standby state to the power transmission state by lowering the impedance of the impedance variable device in a first case where the primary-side detection circuit detects an increase in the magnetic flux interlinked with the primary-side coil or the magnetic flux near the primary-side coil, and
transition from the power transmission state to the standby state by increasing the impedance of the impedance variable device in a second case where the primary-side detection circuit detects a decrease in the magnetic flux interlinked with the primary-side coil or the magnetic flux near the primary-side coil.

3. The wireless power supply system according to claim 2, wherein
as long as the primary-side power reduction control is being performed, the primary-side control circuit is configured to cause no transition from the standby state to the power transmission state even in the first case.

4. The wireless power supply system according to claim 3, wherein
the power transmission apparatus further includes a voltage detection circuit configured to detect a voltage supplied to the power transmission apparatus, wherein
as long as the voltage detected by the voltage detection circuit is less than a preset threshold, the primary-side control circuit is configured to cause no transition from the standby state to the power transmission state even in the first case.

5. The wireless power supply system according to claim 1, wherein
in a case where the primary-side power reduction control is being performed, the power source voltage controller is configured to issue a notification indicating that the primary-side power reduction control is being performed to the power receiving apparatus.

6. The wireless power supply system according to claim 5, wherein
as long as the primary-side power reduction control is being performed, the power source voltage controller is configured to prohibit start of further power supply to the power receiving apparatus.

7. The wireless power supply system according to claim 5, wherein
the power-receiving-side controller is configured to control, in response to receiving the notification, the rectifier circuit to perform a secondary-side power reduction control to reduce a secondary-side power to be supplied to the load equipment, thereby reducing the secondary-side power so that a ratio of the secondary-side power after the secondary-side power reduction control is performed to the secondary-side power before the secondary-side power reduction control is performed reaches a set reduction ratio.

8. The wireless power supply system according to claim 7, wherein
the reduction ratio is a value given by dividing the rated output power of the AC power source apparatus by a value given by multiplying a rated consumption power of the power receiving apparatus by the number of the power receiving apparatus.

9. The wireless power supply system according to claim 7, wherein
the reduction ratio is a value given by dividing a rated output voltage of the AC power source apparatus by a current value of the output voltage.

10. A non-transitory computer-readable storage medium storing a computer program for controlling a wireless power supply system,
the wireless power supply system including:
an AC power source apparatus configured to supply an AC power with a predetermined operation frequency;
a plurality of power transmission apparatuses connected in parallel with respect to the AC power source apparatus, the plurality of power transmission apparatuses including a primary-side resonant circuit including a primary-side coil and a primary-side capacitor; and
a power receiving apparatus configured to be supplied with power from the power transmission apparatuses in a wireless manner, the power receiving apparatus including:
a secondary-side resonant circuit including a secondary-side coil for magnetic coupling with the primary-side coil and a secondary-side capacitor;
a rectifier circuit configured to rectify the AC power outputted from the secondary-side resonant circuit and convert the AC power to a DC power;
a power-receiving-side controller configured to control the rectifier circuit; and
load equipment configured to be supplied with the DC power at a constant current,
the computer program being configured to cause, in a case where an output power of the AC power source apparatus exceeds a rated output power of the AC power source apparatus, a computer to implement a function to lower an output voltage of the AC power source apparatus so that the output power falls below a preset allowable output power.
